(19) United States
(12) Patent Application Publication
(10) Pub. No.: US 2012/0180003 A1
(43) Pub. Date: Jul. 12, 2012

(54) IMAGE FORMING APPARATUS AND TERMINAL DEVICE EACH HAVING TOUCH PANEL

(75) Inventors: Kazumi SAWAYANAGI, Itami-shi (JP); Toshimichi IWAI, Kitakatsuragi-gun (JP); Takehisa YAMAGUCHI, Ikoma-shi (JP); Tomo TSUBOI, Itami-shi (JP); Akihiro TORIGOSHI, Amagasaki-shi (JP)

(73) Assignee: Konica Minolta Business Technologies, Inc, Tokyo (JP)

(21) Appl. No.: 13/347,328

(22) Filed: Jan. 10, 2012

(30) Foreign Application Priority Data
Jan. 12, 2011 (JP) 2011-003882

(51) Int. Cl. G06F 3/033

(52) U.S. Cl. 715/863

(57) ABSTRACT

MFP as an image forming apparatus includes a touch panel, a controller connected to the touch panel, a memory for storing a data file, and a communication device for communicating with another device. Continuously after two contacts are made on the touch panel, when a gesture of moving the two contacts in a direction that a spacing therebetween is decreased and then releasing the two contacts after being moved is detected, the controller identifies a file presented by an icon displayed in an area defined by the two contacts at least either of before and after being moved, as a file to be transferred, and transfers the file to be transferred to the other device in response to a request to transfer a file from the other device received by the communication device.

This application is based on Japanese Patent Application No. 2011-003882 filed with the Japan Patent Office on Jan. 12, 2011, the entire content of which is hereby incorporated by reference.

### BACKGROUND OF THE INVENTION

1. Field of the Invention

The present invention relates to an image forming apparatus and a terminal device, and more particularly to an image forming apparatus and a terminal device in which operations are executed by user's “pinch-in (pinch-close)” and “pinch-out (pinch-open)” gestures on a touch panel.

2. Description of the Related Art

Some of image forming apparatuses, such as a copier, a printer and their compound machine, MFP (Multi-Functional Peripheral), store image data as a file.

When an image forming apparatus and another device such as a personal digital assistant, for example, are connected to a network, an envisaged use is to transmit and receive a file between these devices through the network.

Conventionally, when transmitting and receiving a file between such an image forming apparatus and another device through a network, operations or manipulations of selecting a file to be transmitted in a device on the transmitting side, and then selecting a destination device on the receiving side referring to the network are necessary. This imposes a complicated manipulation on a user, requires the address of a destination to be identified, and is troublesome.

Moreover, when these devices each have a touch panel as an input device, a conventionally typical operation is to cause options to be displayed on the touch panel in each device and touch one of them that is desired to be indicated. Such an operation is not an intuitive manipulation, which is more complicated for an unfamiliar user.

### SUMMARY OF THE INVENTION

The present invention was made in view of such problems, and has an object to provide an image forming apparatus and a terminal device capable of transmitting and receiving a file with intuitive and easy manipulations between the devices connected through a network.

To achieve the above-described object, according to an aspect of the present invention, an image forming apparatus includes a touch panel, a controller connected to the touch panel, a memory for storing a data file, and a communication device for communicating with an other device. Continuously after two contacts are made on the touch panel, when a first gesture of moving the two contacts in a direction that a spacing therebetween is decreased and then releasing the two contacts after being moved is detected, the controller identifies a file presented by an icon displayed in an area defined by the two contacts at least either of before and after being moved, as a file to be transferred, and transfers the file to be transferred to the other device in response to a request to transfer a file from the other device received by the communication device.

Preferably, the controller performs user authentication using user information to associate the file to be transferred with a user having performed the first gesture, and when a user identified by information included in the request matches the user associated with the file to be transferred, transfers the file to be transferred to the other device.

Preferably, the controller outputs the file to be transferred to the other device in response to the request sent after the first gesture, thereby transferring the file to be transferred to the other device.

Preferably, the controller previously stores the other device as a destination of the file to be transferred, and outputs the file to be transferred to the other device after the first gesture and before the request, thereby transferring the file to be transferred to the other device.

More preferably, the controller copies the file to be transferred, outputs the copied file to the other device, and deletes the file to be transferred from the memory in response to the request from the other device.

Preferably, when the request is not sent within a predetermined period after identification of the file to be transferred, the controller cancels identification of the file to be transferred.

Preferably, continuously after two contacts are made, when a second gesture of moving the two contacts in a direction that the spacing therebetween is increased and then releasing the two contacts after being moved is detected on display of the touch panel showing a folder presenting a storage location where the file to be transferred is stored, the controller cancels identification of the file to be transferred.

Preferably, when the request is not sent within a predetermined period after identification of the file to be transferred, the controller causes a warning to that effect to be output.

Preferably, the controller identifies a plurality of files presented by a plurality of icons displayed in the area defined by the two contacts at least either of before and after being moved, as files to be transferred.

Preferably, when an icon presenting a folder is displayed in the area defined by the two contacts at least either of before and after being moved, the controller identifies a plurality of files stored in the folder as files to be transferred.

Preferably, when the first gesture is detected, the controller changes the shape of the icon displayed between the two contacts along with moving the two contacts.

Preferably, continuously after two contacts are made on the touch panel, when a second gesture of moving the two contacts in a direction that the spacing therebetween is increased and then releasing the two contacts after being moved is detected, the controller further executes the processes of identifying a storage location displayed in the area defined by the two contacts at least either of before and after being moved, as the storage location of the file to be transferred, sending a request to the other device to transfer a file, and storing the file transmitted from the other device in the storage location.

According to another aspect of the present invention, a terminal device includes a touch panel, a controller connected to the touch panel, and a communication device for communicating with an image forming apparatus. Continuously after two contacts are made on the touch panel, when a first gesture of moving the two contacts in a direction that a spacing therebetween is increased and then releasing the two contacts after being moved is detected, the controller executes the processes of identifying a storage location displayed in an area defined by the two contacts at least either of before and after being moved, as the storage location of a file to be transferred, sending a request to the image forming apparatus to transfer a file, and storing the file to be transferred transmitted from the image forming apparatus in the storage location.

Preferably, the controller transmits information that identifies a user previously stored together with the request, to the image forming apparatus.

Preferably, the request includes information indicating that the first gesture has been detected.

Preferably, when the first gesture is detected, the controller causes an icon presenting the file to be transferred transmitted from the image forming apparatus to be displayed between the two contacts, and changes the shape of the icon displayed along with moving the two contacts.

Preferably, the file to be transferred transmitted from the image forming apparatus has associated therewith information at the time of identification of the file to be transferred in the image forming apparatus, and the controller causes the information at the time of identification of the file to be transferred in the image forming apparatus to be displayed together with the icon.

Preferably, continuously after two contacts are made on the touch panel, when a second gesture of moving the two contacts in a direction that the spacing therebetween is decreased and then releasing the two contacts after being moved is detected, the controller identifies a file presented by an icon displayed in the area defined by the two contacts at least either of before and after being moved, as a file to be transferred, and transfers the file to be transferred to the image forming apparatus in response to a request from the image forming apparatus received by the communication device.

According to still another aspect of the present invention, an image forming system includes an image forming apparatus and a terminal device. The image forming apparatus and the terminal device each include a touch panel and a controller connected to the touch panel. Continuously after two contacts are made on the touch panel, when a first gesture of moving the two contacts in a direction that a spacing therebetween is decreased and then releasing the two contacts after being moved is detected, the controller of a first device out of the image forming apparatus and the terminal device identifies a file presented by an icon displayed in an area defined by the two contacts at least either of before and after being moved, as a file to be transferred, and transfers the file to be transferred to a second device out of the image forming apparatus and the terminal device in response to a request from the second device. Continuously after two contacts are made on the touch panel, when a second gesture of moving the two contacts in a direction that the spacing therebetween is increased and then releasing the two contacts after being moved is detected, the controller of the second device executes the processes of identifying a storage location displayed in the area defined by the two contacts at least either of before and after being moved, as the storage location of the file to be transferred, sending a request to transfer a file, and storing the file to be transferred transmitted from the second device in the storage location.

Preferably, the image forming system further includes a server. The controller of the first device transmits the file to be transferred to the server for storage. The controller of the second device requests the server to transfer a file. The controller of the first device outputs the file to be transferred as stored to the second device in response to the request.

According to a further aspect of the present invention, a non-transitory computer-readable storage medium has recorded thereon a program for causing an image processing apparatus having a touch panel and a controller connected to the touch panel to execute a process of transferring a stored file to an other device. The program instructs the controller to perform the following steps of continuously after two contacts are made on the touch panel, detecting a gesture of moving the two contacts in a direction that a spacing therebetween is decreased and then releasing the two contacts after being moved, when the gesture is detected, identifying a file presented by an icon displayed in an area defined by the two contacts at least either of before and after being moved, as a file to be transferred, and transferring the file to be transferred to the other device in response to a request to transfer a file from the other device.

According to a still further aspect of the present invention, a non-transitory computer-readable storage medium has recorded thereon a program for causing a terminal device having a touch panel and a controller connected to the touch panel to execute a process of transferring a file stored in an image processing apparatus to the terminal device. The program instructs the controller to perform the following steps of continuously after two contacts are made on the touch panel, detecting a gesture of moving the two contacts in a direction that a spacing therebetween is increased and then releasing the two contacts after being moved, when the gesture is detected, identifying a storage location displayed in an area defined by the two contacts at least either of before and after being moved, as the storage location of a file to be transferred, when the gesture is detected in the detecting step, sending a request to the image processing apparatus to transfer a file, receiving the file to be transferred transmitted from the image processing apparatus, and storing the file to be transferred in the storage location.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a specific example of a configuration of an image forming system according to an embodiment.

FIG. 2 shows a specific example of a hardware configuration of MFP (Multi-Functional Peripheral) included in the image forming system.

FIG. 3 shows a specific example of a hardware configuration of a portable terminal included in the image forming system.

FIG. 4 shows a specific example of a hardware configuration of a server included in the image forming system.

FIGS. 5 and 6 show the outline of operations in the image forming system.

FIG. 7 illustrates a pinch-in gesture.

FIG. 8 illustrates a pinch-out gesture.

FIG. 9 is a block diagram showing a specific example of a functional configuration of MFP.

FIG. 10 is a block diagram showing a specific example of a functional configuration of the portable terminal.

FIG. 11 is a flow chart showing a specific example of an operation in MFP for identifying a file to be transferred.

FIG. 12 is a flow chart showing a specific example of an operation in MFP for outputting the file to be transferred.

FIG. 13 is a flow chart showing a specific example of an operation in the portable terminal for acquiring and storing the file to be transferred.

FIG. 14 shows a specific example of a data configuration of a file request transmitted from the portable terminal to MFP in Step S205 of FIG. 13.

FIG. 15 is a sequence diagram showing the flow of file transfer in the image forming system.

FIG. 16 shows a specific example of changes of an icon along with the pinch-in gesture.

FIG. 17 shows a specific example of changes of an icon along with the pinch-out gesture.

FIGS. 18 to 22 each illustrate a specific example of a method of identifying an icon indicated by the pinch-in gesture.

### DESCRIPTION OF THE PREFERRED EMBODIMENTS

Hereinafter, embodiments of the present invention will be described with reference to the drawings. In the following description, like parts and components are denoted by like reference characters. They are named and function identically as well.

### System Configuration

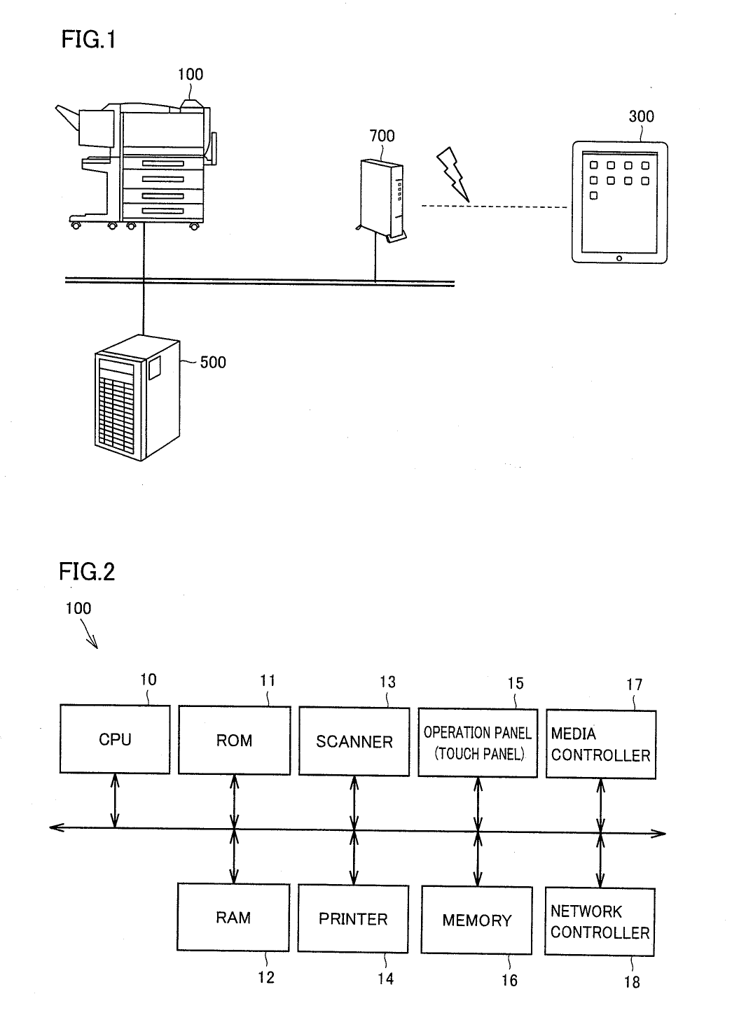

FIG. 1 shows a specific example of a configuration of an image forming system according to the present embodiment.

Referring to FIG. 1, the image forming system according to the present embodiment includes an MFP (Multi-Functional Peripheral) 100 as an example of an image forming apparatus, a portable terminal 300 as a terminal device, and a server 500. They are connected through a network, such as LAN (Local Area Network).

The network may be wired or may be wireless. As an example, as shown in FIG. 1, MFP 100 and server 500 are connected to a wired LAN, the wired LAN further including a wireless LAN access point 700, and portable terminal 300 is connected to wireless LAN access point 700 through the wireless LAN.

### Configuration of MFP

FIG. 2 shows a specific example of a hardware configuration of MFP 100.

Referring to FIG. 2, MFP 100 includes a CPU (Central Processing Unit) 10 as an arithmetic device for overall control, a ROM (Read Only Memory) 11 for storing programs and the like to be executed by CPU 10, a RAM (Random Access Memory) 12 for functioning as a working area during execution of a program by CPU 10, a scanner 13 for optically reading a document placed on a document table not shown to obtain image data, a printer 14 for fixing image data on a printing paper, an operation panel 15 including a touch panel for displaying information and receiving an operation input to MFP 100 concerned, a memory 16 for storing image data as a file, a media controller 17 for controlling communications to a recording medium, such as a USB (Universal Serial Bus) memory, for accessing the recording medium to read/write a file therefrom/therein, and a network controller 18 for controlling communications through the above-described network.

Operation panel 15 includes the touch panel and an operation key group not shown. The touch panel is composed of a display device such as a liquid crystal display and a pointing device such as an optical touch panel or a capacitance touch panel, the display device and the pointing device overlapping each other, and displays an operation screen so that an indicated position on the operation screen is identified. CPU 10 causes the touch panel to display the operation screen based on data stored previously for causing screen display.

The indicated position (position of touch) on the touch panel as identified and an operation signal indicating a pressed key are input to CPU 10. CPU 10 identifies details of manipulation based on the pressed key or the operation screen being displayed and the indicated position, and executes a process based thereon.

### Configuration of Portable Terminal

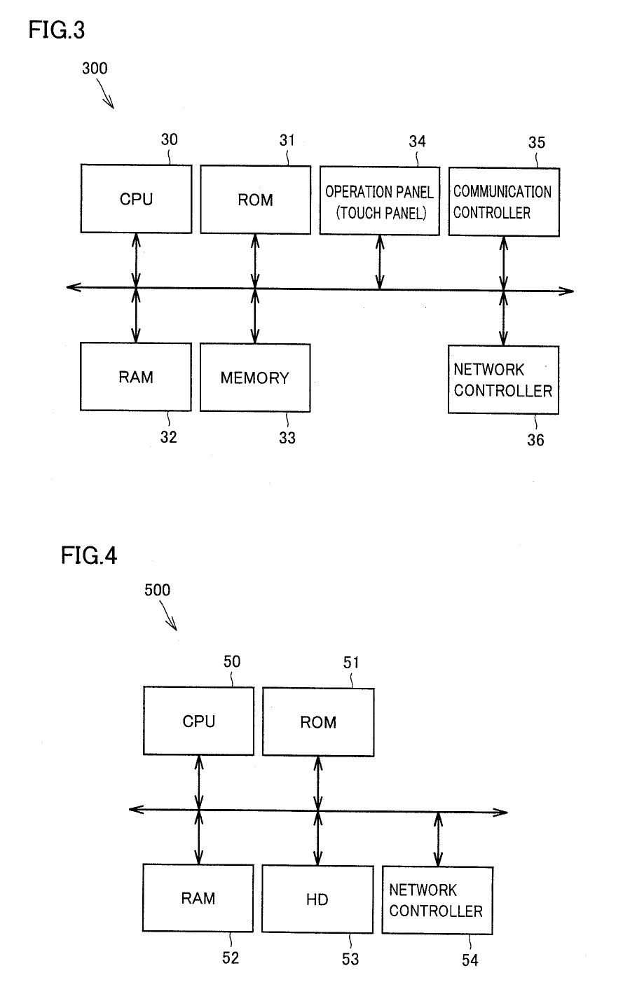

FIG. 3 shows a specific example of a hardware configuration of portable terminal 300.

Referring to FIG. 3, portable terminal 300 includes a CPU 30 as an arithmetic device for overall control, a ROM 31 for storing programs and the like to be executed by CPU 30, a RAM 32 for functioning as a working area during execution of a program by CPU 30, a memory 33 for storing image data as a file or storing another type of information, an operation panel 34 including a touch panel for displaying information and receiving an operation input to portable terminal 300 concerned, a communication controller 35 for controlling communications through telephone lines by communicating with a base station not shown, and a network controller 36 for controlling communications through the above-described network.

Operation panel 34 may have a configuration similar to that of operation panel 15 of MFP 100. That is, as an example, operation panel 34 includes a touch panel composed of a display device such as a liquid crystal display and a pointing device such as an optical touch panel or a capacitance touch panel, the display device and the pointing device overlapping each other.

CPU 30 causes the touch panel to display an operation screen based on data stored previously for causing screen display. On the touch panel, the indicated position on the operation screen is identified, and an operation signal indicating that position is input to CPU 30. CPU 30 identifies details of manipulation based on the operation screen being displayed and the indicated position, and executes a process based thereon.

### Configuration of Server

FIG. 4 shows a specific example of a hardware configuration of server 500.

Referring to FIG. 4, server 500 is implemented by a typical computer or the like as described above, and as an example, includes a CPU 50 as an arithmetic device for overall control, a ROM 51 for storing programs and the like to be executed by CPU 50, a RAM 52 for functioning as a working area during execution of a program by CPU 50, a HD (Hard Disk) 53 for storing files and the like, and a network controller 54 for controlling communications through the above-described network.

### Outline of Operations

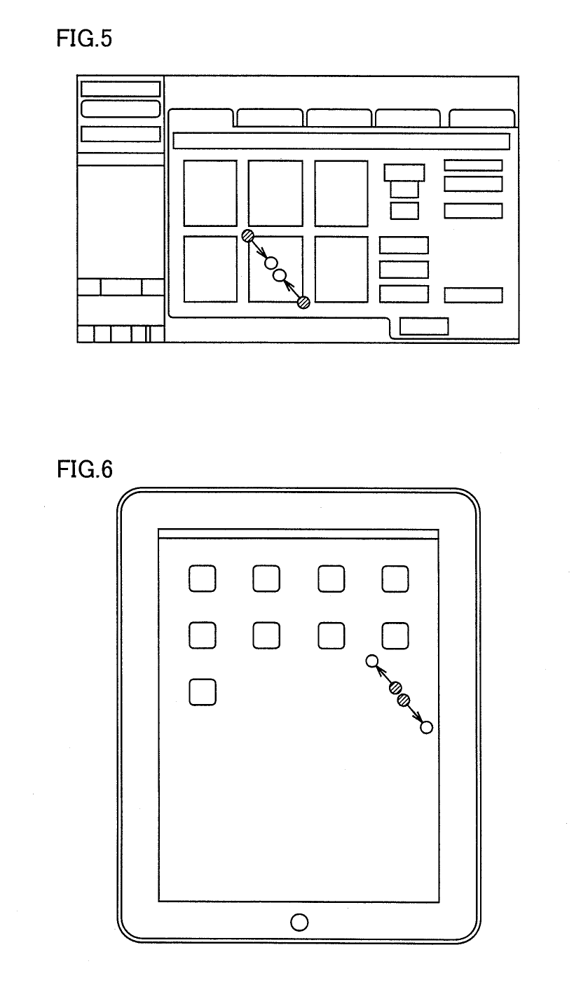

In the image forming system according to the present embodiment, a file is transferred from MFP 100 to portable terminal 300 according to gestures shown in FIGS. 5 and 6. As an example, file transfer shall be performed during a gesture on portable terminal 300.

FIGS. 5 and 6 show the outline of operations in the image forming system according to the present embodiment. A user logs in to MFP 100, and causes operation panel 15 to display a file list stored in an indicated memory area, such as a memory area associated with himself/herself. FIG. 5 shows an example in which the file list is displayed on operation panel 15. By performing a “pinch-in” gesture as shown in FIG. 5 on an icon indicating a file to be transferred in the file list, that file is identified to be transferred. Then, the user causes operation panel 34 of his/her own portable terminal 300 to display the operation screen. FIG. 6 shows an example in which the operation screen is displayed on operation panel 34. By performing a “pinch-out” gesture thereon as shown in FIG. 6, the file identified to be transferred is transferred from MFP 100 to portable terminal 300.

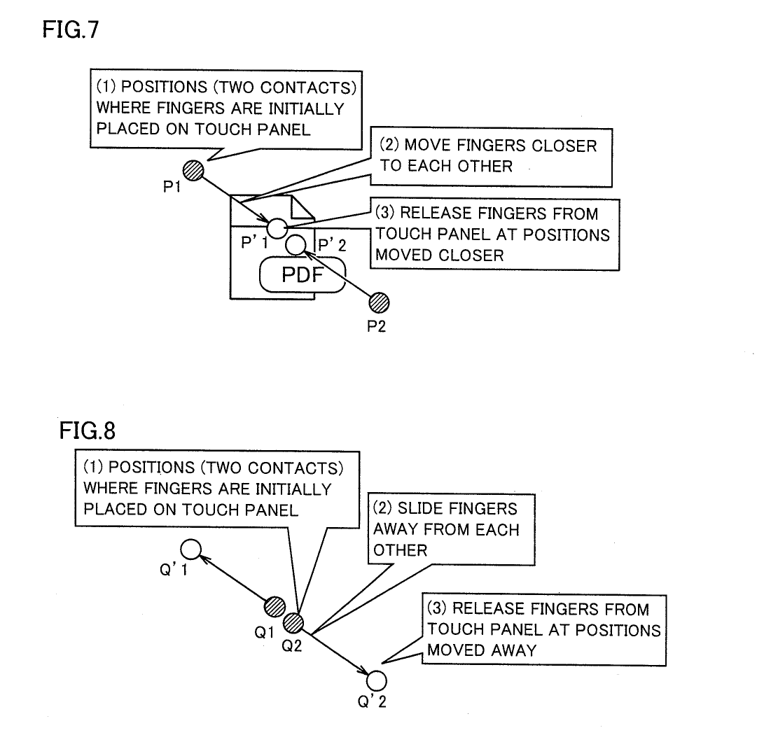

FIG. 7 illustrates a “pinch-in” gesture. Referring to FIG. 7, the “pinch-in” or pinching gesture refers to a motion of making two contacts P1 and P2 on operation panel 15 using, for example, two fingers or the like, and then moving the fingers closer to each other from their initial positions linearly or substantially linearly, and releasing the two fingers from operation panel 15 at two contacts P′1 and P′2 moved closer.

When it is detected that two contacts P1 and P2 on operation panel 15 have been made simultaneously, and further, the respective contacts have been continuously displaced from their initial positions linearly or substantially linearly, and both the contacts have been released almost simultaneously at two contacts P′1 and P′2 positioned at a spacing narrower than the spacing between their initial positions, CPU 10 detects that the “pinch-in” gesture has been performed.

FIG. 8 illustrates a “pinch-out” gesture. Referring to FIG. 8, the “pinch-out” or anti-pinching gesture refers to a motion of making two contacts Q1 and Q2 on operation panel 34 using, for example, two fingers or the like, and then moving the fingers away from their initial positions linearly or substantially linearly, and releasing the two fingers from operation panel 34 at two contacts Q′1 and Q′2 moved away to some degree.

When it is detected that two contacts Q1 and Q2 on operation panel 34 have been made simultaneously, and further, the respective contacts have been continuously displaced from their initial positions linearly or substantially linearly, and both the contacts have been released almost simultaneously at two contacts Q′1 and Q′2 positioned at a spacing wider than the spacing between their initial positions, CPU 30 detects that the “pinch-out” or de-pinching gesture has been performed.

### Functional Configuration

The functional configuration of each device for implementing the operations as described in the outline of operations in the image forming system according to the present embodiment will be described.

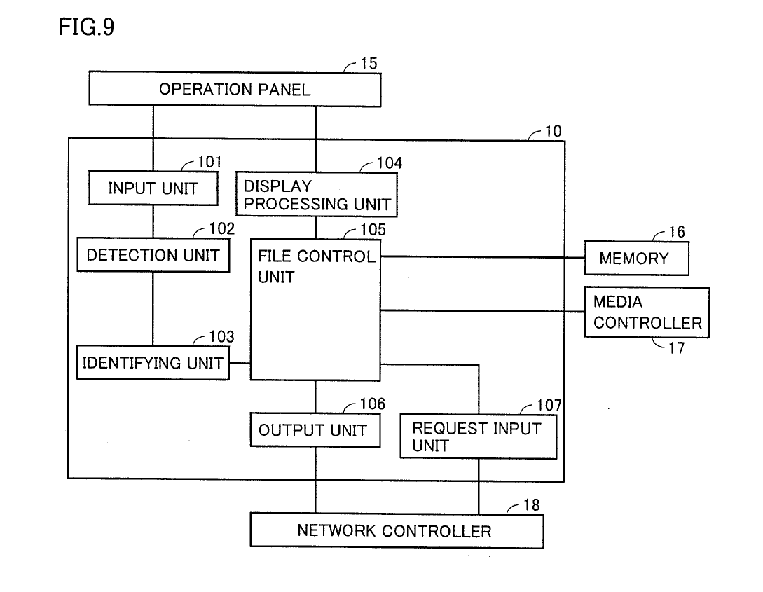

FIG. 9 is a block diagram showing a specific example of a functional configuration of MFP 100. Each function shown in FIG. 9 is a function mainly configured in CPU 10 by CPU 10 reading a program stored in ROM 11 and executing the program on RAM 12. However, at least some functions may be configured by the hardware configuration shown in FIG. 2.

Referring to FIG. 9, as functions for achieving the above-described operations, MFP 100 includes an input unit 101 for receiving input of an operation signal indicating an instruction on operation panel 15, a detection unit 102 for detecting the above-described pinch-in gesture based on the operation signal, an identifying unit 103 for identifying an icon indicated by the pinch-in gesture based on the indicated position presented by the operation signal, a display processing unit 104 for executing a process of achieving display on operation panel 15, a file control unit 105 for executing a process of outputting an identified file among files stored in memory 16 or an external storage medium accessed by media controller 17, an output unit 106 for outputting the identified file to an indicated device through network controller 18, and a request input unit 107 for receiving input of a request for the above-described file from another device through network controller 18.

Identifying unit 103 identifies an icon, displayed in an area defined based on at least either two contacts (two contacts P1, P2 in FIG. 7) indicated initially in the pinch-in gesture or two contacts (two contacts P′1, P′2 in FIG. 7) indicated finally, as an icon indicated by the pinch-in gesture.

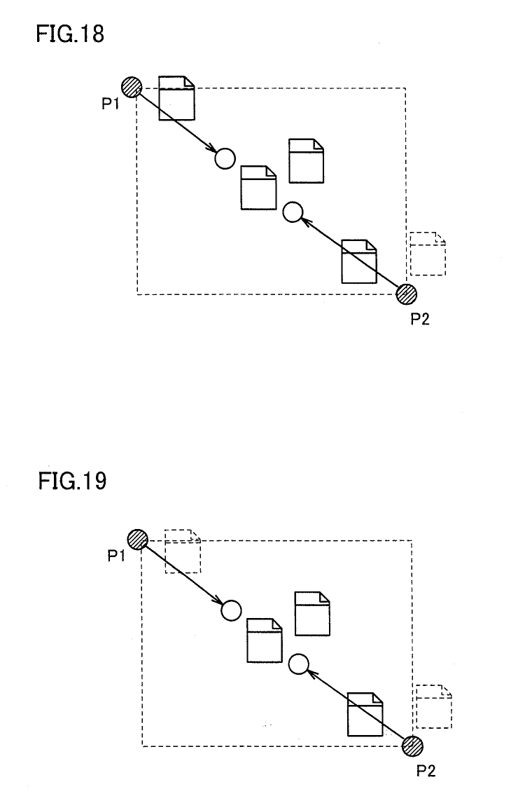

The method of identifying an icon indicated by the pinch-in gesture in identifying unit 103 is not limited to a certain method. FIGS. 18 to 22 each illustrate a specific example of a method of identifying an icon indicated by the pinch-in gesture in identifying unit 103.

As an example, as shown in FIG. 18, identifying unit 103 may identify a rectangle in which two contacts P1 and P2 indicated initially are at opposite corners as an area defined by the pinch-in gesture, and may identify icons, each of which is at least partially included in that rectangle, may be identified as indicated icons. Alternatively, as shown in FIG. 19, a rectangle in which two contacts P1 and P2 indicated initially are at opposite corners may be identified as an area defined by the pinch-in gesture, and icons completely included in that rectangle may be identified as indicated icons. With such identification, the user can indicate an intended file by touching operation panel 15 with two fingers so as to sandwich an icon presenting a file to be transferred, and performing a motion for the pinch-in gesture from that state. The file to be transferred can thus be indicated in an intuitive manner. Even when an icon image is small, it can be indicated correctly.

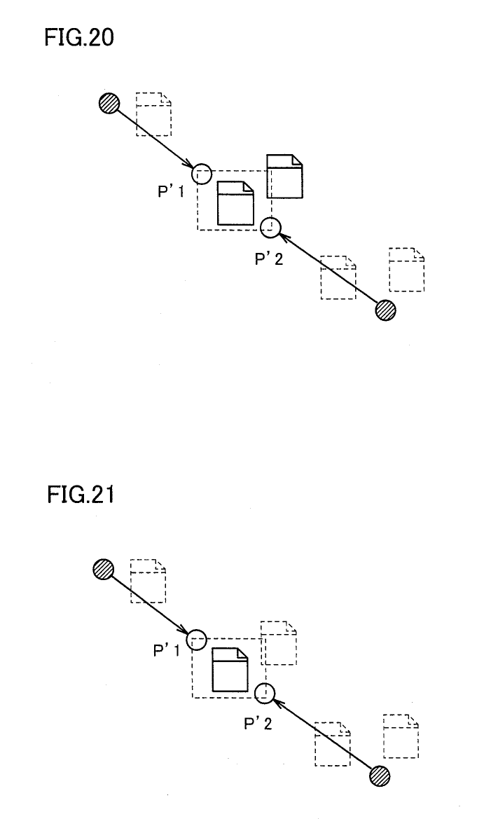

As another example, as shown in FIG. 20, identifying unit 103 may identify a rectangle in which two contacts P′1 and P′2 indicated finally are at opposite corners as an area defined by the pinch-in gesture, and may identify icons, each of which is at least partially included in that rectangle, may be identified as indicated icons. Alternatively, as shown in FIG. 21, a rectangle in which two contacts P′1 and P′2 indicated finally are at opposite corners may be identified as an area defined by the pinch-in gesture, and an icon completely included in that rectangle may be identified as an indicated icon. With such identification, the user can indicate an intended file by touching operation panel 15 with two fingers spaced apart, and then moving them closer to each other so that an icon presenting a file to be transferred is sandwiched finally between the two fingers. The file to be transferred can thus be indicated in an intuitive manner. Even when an icon image is small, it can be indicated correctly.

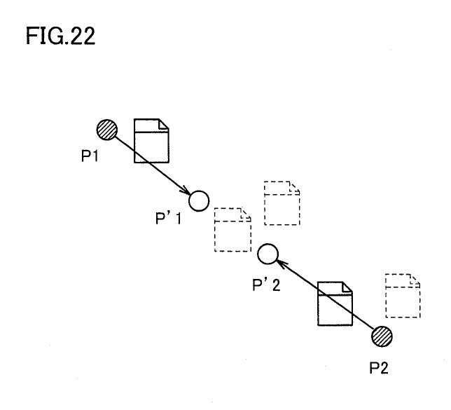

As still another example, as shown in FIG. 22, identifying unit 103 may identify two lines that connect two contacts P1, P2 indicated initially and two contacts P′1, P′2 indicated finally, respectively, as areas defined by the pinch-in gesture, and may identify icons where either one line overlaps as indicated icons. With such identification, the user can indicate an intended file by moving the two fingers so as to pinch in an icon presenting a file to be transferred. The file to be transferred can thus be indicated in an intuitive manner. Even when an icon image is small, it can be indicated correctly.

File control unit 105 temporarily stores the file identified by the pinch-in gesture as a file to be transferred. This “temporary” period is previously set at 24 hours, for example, and when there is no file request, which will be described later, received from another device after the lapse of that period, identification to be transferred may be cancelled. Further, when there is no file request received within the above-described temporary period, CPU 10 may cause operation panel 15 to display a warning reading that file transfer has not been completed, instead of or in addition to cancellation of identification to be transferred, or may transmit a message to that effect to portable terminal 300 stored in correspondence with the user associated with the file to be transferred.

As another example of canceling identification to be transferred, control unit 105 may cancel identification to be transferred by detecting a pinch-in gesture again on a folder in which the icon of the file indicated to be transferred has been displayed, instead of the case when there is no file request received within the above-described temporary period or in addition to the case when there is no file request.

It is to be noted that, although not shown in FIG. 9, MFP 100 further includes the function for previously storing user information, receiving, at input unit 101, input of an operation signal based on a login operation on operation panel 15, and performing user authentication based on that operation signal and user information. File control unit 105 stores the file to be transferred in association with information that identifies the login user. A file request from portable terminal 300 received by request input unit 107 includes information that identifies the user, such as the user name and login information of portable terminal 300 as well as identification information specific to portable terminal 300, as will be described later. File control unit 105 previously stores the login information or the above-described information that identifies the user, and authenticates whether or not the user identified by information included in the file request matches the user associated with the file to be transferred, and when a match occurs, transmits the file to be transferred.

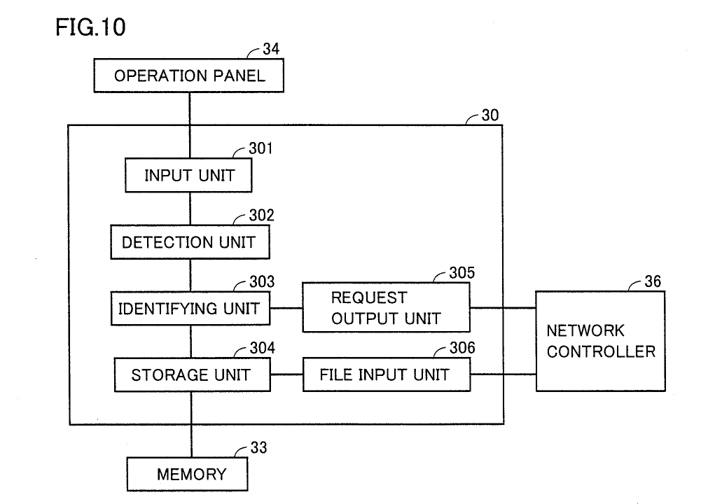

FIG. 10 is a block diagram showing a specific example of a functional configuration of portable terminal 300. Each function shown in FIG. 10 is a function mainly configured in CPU 30 by CPU 30 reading a program stored in ROM 31 and executing the program on RAM 32. However, at least some functions may be configured by the hardware configuration shown in FIG. 3.

Referring to FIG. 10, as functions for achieving the above-described operations, portable terminal 300 includes an input unit 301 for receiving input of an operation signal indicating an instruction on operation panel 34, a detection unit 302 for detecting the above-described pinch-out gesture based on the operation signal, an identifying unit 303 for identifying a position indicated by the pinch-out gesture based on the indicated position presented by the operation signal and identifying a storage location on memory 33 presented by that position, a request output unit 305 for outputting a file request through network controller 36 to an address on the network of MFP 100 previously stored based on the detected pinch-out gesture, a file input unit 306 for receiving a file output from MFP 100 in response to the above-described request through network controller 36, and a storage unit 304 for executing a process of storing the input file in the identified storage location.

Identifying unit 303 identifies a folder, displayed in an area defined based on at least either two contacts (two contacts Q1, Q2 in FIG. 8) indicated initially in the pinch-out gesture or two contacts (two contacts Q′1, Q′2 in FIG. 8) indicated finally, as a folder as a storage location indicated by the pinch-out gesture. The method of identifying a storage location indicated by the pinch-out gesture in identifying unit 303 is not limited to a certain method. The method can include an identifying method similar to the identifying method in the pinch-in gesture described with reference to FIGS. 18 to 22.

However, when identifying a single storage location by the pinch-out gesture and when a plurality of folders are displayed in a defined area, a folder displayed closest to two indicated contacts (two contacts Q1, Q2 in FIG. 8) may be identified as a storage location, for example. Alternatively, when a plurality of folders are identified as storage locations by the pinch-out gesture by an identifying method similar to that of FIGS. 18 to 22, all of them may be identified as storage locations. In this case, storage unit 304 may copy the file to be transferred by the number of the identified storage locations, and may store copied files in the storage locations, respectively.

Request output unit 305 stores the user name and login information of portable terminal 300 concerned as well as identification information specific to portable terminal 300, as information that identifies the user associated previously with portable terminal 300, and outputs a file request together with the information that identifies the user to MFP 100, as will be described later.

### Flow of Operations in MFP

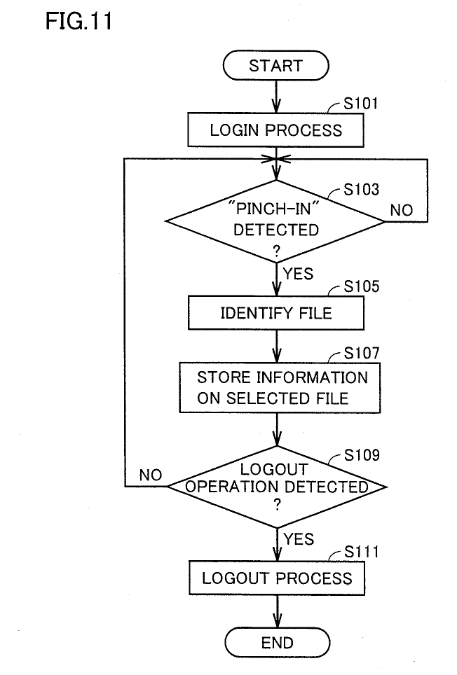

FIG. 11 is a flow chart showing a specific example of operations in MFP 100 for identifying a file to be transferred. The operations shown in the flow chart of FIG. 11 are implemented by CPU 10 reading a program stored in ROM 11 and executing the program on RAM 12.

Referring to FIG. 11, in Step S101, CPU 10 executes a login process by receiving a login operation. Then, when it is detected that the pinch-in gesture has been performed on a file list displayed on operation panel 15 (YES in Step S103), CPU 10, in Step S105, identifies a file indicated by that gesture, and in Step S107, temporarily stores the identified file in association with identification information of the login user identified by the login process in Step S101.

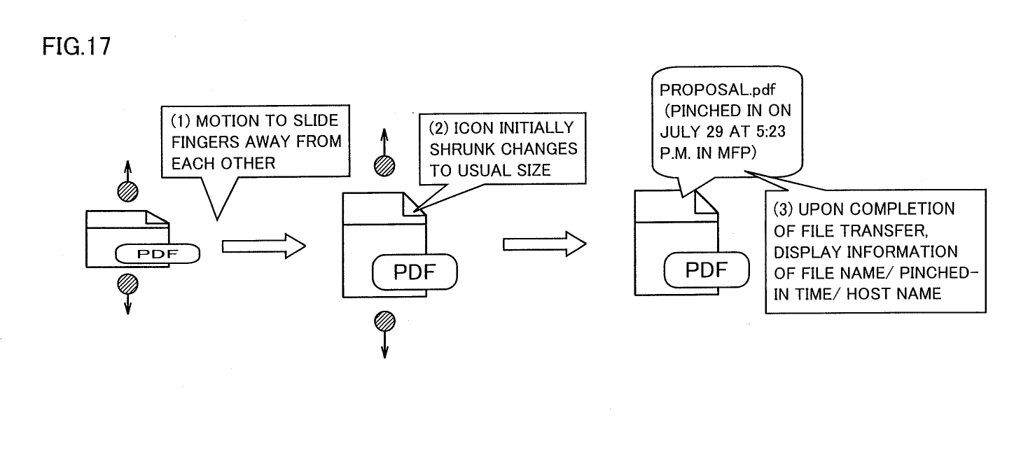

At this time, preferably, CPU 10 changes the shape of the icon displayed between two contacts on operation panel 15 when the start of the above-described pinch-in gesture is detected. FIG. 16 shows a specific example of changes of the icon along with the pinch-in gesture. Referring to FIG. 16, when the start of the pinch-in gesture is detected, CPU 10 causes the icon displayed between the two contacts on operation panel 15 to be changed in shape so as to shrink in the moving direction (sliding direction) of the above-described two contacts. This may be implemented by gradually compressing image data of the icon stored previously in the sliding direction, or may be implemented by previously storing several types of image data and causing the image data to be displayed sequentially.

Thus causing the icon to be displayed, it will be shown in an intuitive manner that a file has been identified as a file to be transferred by the pinch-in gesture.

The above operation is repeated until a logout operation is detected (NO in Step S109). Therefore, a plurality of files may be identified as files to be transferred by the above-described operation performed several times until a logout operation is detected. Alternatively, a plurality of files may be identified as files to be transferred in correspondence with the pinch-in gesture performed on a folder or on a plurality of files.

When a logout operation is detected (YES in Step S109), CPU 10 executes a logout process in Step S111, and terminates the sequential processing of identifying a file to be transferred.

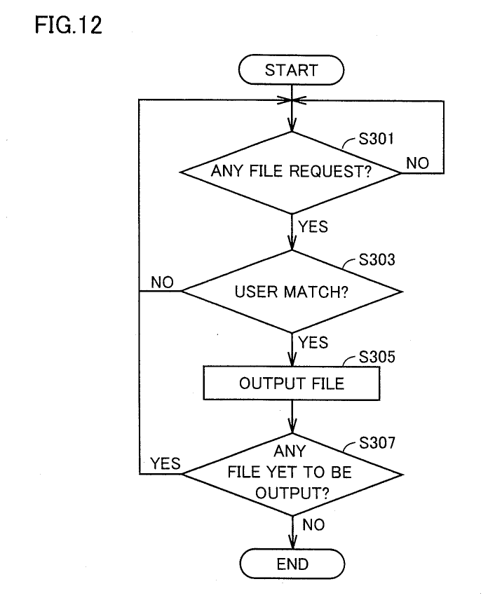

FIG. 12 is a flow chart showing a specific example of an operation in MFP 100 for outputting a file to be transferred. The operation shown in the flow chart of FIG. 12 is also implemented by CPU 10 reading a program stored in ROM 11 and executes the program on RAM 12.

Referring to FIG. 12, upon receipt of a file request from portable terminal 300 (YES in Step S301), CPU 10 authenticates whether or not the user associated with the file temporarily stored as the file to be transferred by the operation shown in FIG. 11 matches a user identified by information included in the request. When a match occurs (YES in Step S303), CPU 10 in Step S305 outputs the file to be transferred as stored temporarily to portable terminal 300 as a requester. When another file to be transferred yet to be output is stored (YES in Step S307), CPU 10 repeats the above process. Accordingly, even when a plurality of files are identified as files to be transferred, they will be transferred to portable terminal 300.

When all the files to be transferred stored in association with the user concerned are output (NO in Step S307), CPU 10 terminates the sequential processing of outputting the files to be transferred.

### Flow of Operations in Portable Terminal

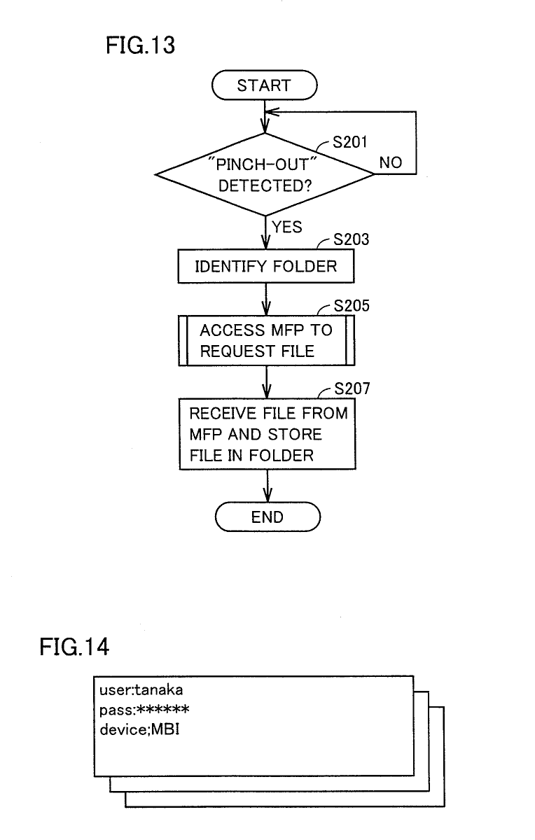

FIG. 13 is a flow chart showing a specific example of operations in portable terminal 300 for acquiring and storing a file to be transferred. The operations shown in the flow chart of FIG. 13 are implemented by CPU 30 reading a program stored in ROM 31 and executes the program on RAM 32.

Referring to FIG. 13, when it is detected that the pinch-out gesture has been performed on the operation screen displayed on operation panel 34 (YES in Step S201), CPU 30 in Step S203 identifies a position on the operation screen where the pinch-out gesture has been performed, thereby identifying a folder to be a storage location of the acquired file.

Then, in Step S205, CPU 30 accesses MFP 100 using the address of MFP 100 on the network stored previously, and requests a file to be transferred. FIG. 14 shows a specific example of a data configuration of a file request transmitted from portable terminal 300 to MFP 100 in Step S205. In Step S205, CPU 30 transmits the user name and a password of portable terminal 300 stored previously as well as identification information specific to portable terminal 300, as an example of information that identifies the user. The information that identifies the user may be at least one of them. The password may be a password included in information on the user's login to MFP 100, or may be different therefrom.

When the file having been identified to be transferred is transmitted from MFP 100 in response to the above-described request, CPU 30, in Step S207, receives the file and stores it in the folder identified in Step S203 described above, and terminates the sequential operation.

At this time, preferably, when the start of the above-described pinch-out gesture is detected, CPU 30 makes a file request to MFP 100 to acquire a file, and causes an icon presenting that file to be displayed while being changed in shape along with the pinch-out gesture on operation panel 34. FIG. 17 shows a specific example of changes of the icon along with the pinch-out gesture. Referring to FIG. 17, when the start of the above-described pinch-out gesture is detected, CPU 30 acquires a file from MFP 100, and causes an icon presenting that file between two contacts on operation panel 34 to be displayed with its shape shrunk in an opposite direction to subsequent sliding of the two contacts. Then, the icon is changed to expand in the moving direction (sliding direction) of the above-described two contacts. This may be implemented by gradually expanding image data of the icon stored previously in the sliding direction, or may be implemented by previously storing several types of image data and causing the image data to be displayed sequentially.

More preferably, CPU 30 also causes information such as the date and time as well as the user name at the time when that file was identified to be transferred to be displayed together with an icon, as shown in FIG. 17. To implement this, MFP 100 temporarily stores the file to be transferred together with the information that identifies the user and information such as the date and time at the time of identification and the like, and outputs the file to be transferred to portable terminal 300 together with the information.

Thus causing the icon to be displayed, it will be shown in an intuitive manner that the file to be transferred has been acquired by the pinch-out gesture and stored in an identified folder.

### Effects of Embodiment

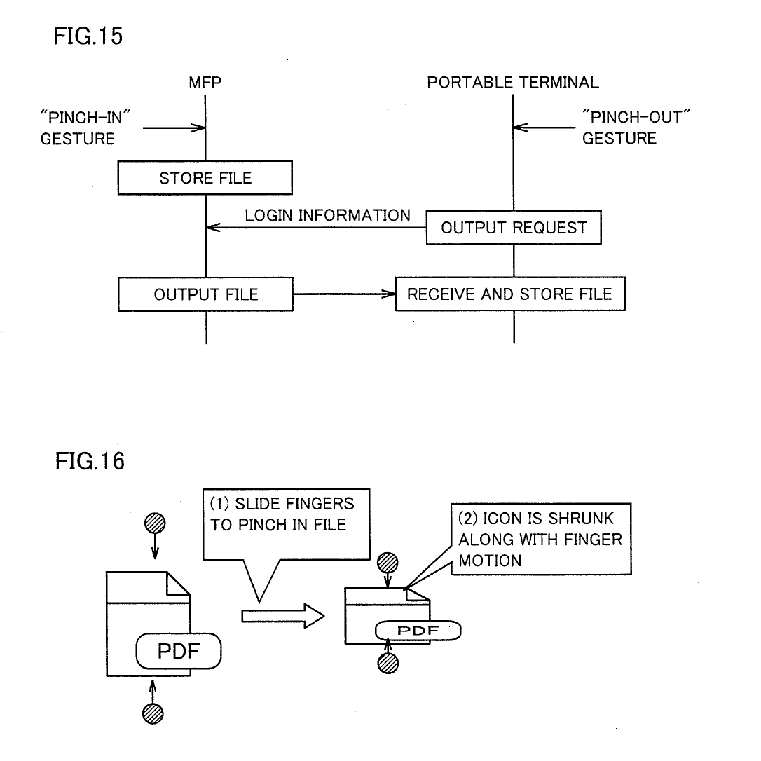

FIG. 15 is a sequence diagram showing the flow of file transfer in the image forming system according to the present embodiment. The operations shown in FIG. 15 are implemented by the above operations being performed in MFP 100 and portable terminal 300.

Referring to FIG. 15, when the user performs the pinch-in gesture on the screen of a file list of MFP 100, a file of concern is identified as a file to be transferred. Then, when the user performs the pinch-out gesture on the operation screen of portable terminal 300, a file request is sent from portable terminal 300 to MFP 100 together with information that can identify the user, such as the user's login information and identification information of portable terminal 300. In MFP 100, when the user is authenticated as the user having indicated the file to be transferred using that information, the identified file to be transferred is output to portable terminal 300. Portable terminal 300, upon receipt of this file, stores the file in the folder identified by the above-described pinch-out gesture.

This allows the user to transfer a file from MFP 100 to portable terminal 300 by intuitive and easy manipulations of pinching a file of concern in MFP 100 as a source and de-pinching the file in a storage location in portable terminal 300 as a destination.

### Variation 1

In the above description, when the pinch-in gesture is detected in MFP 100, the file to be transferred shall be identified, and when the pinch-out gesture is detected on portable terminal 300, the file to be transferred shall be transferred from MFP 100 to portable terminal 300.

However, the timing of transfer is not limited to this timing. As another example, the file to be transferred may be identified when the pinch-in gesture is detected in MFP 100, and further, that file may be output to portable terminal 300 previously stored in association with the user having performed that gesture. At this time, preferably, CPU 10 of MFP 100 copies the file to be transferred stored in memory 16 or an inserted external storage device, and outputs a copied file to portable terminal 300.

In this case, CPU 30 of portable terminal 300 receives the file transmitted from MFP 100, and temporarily stores the file in a preset storage location. At this time, preferably, an icon or the like presenting that file is prevented from being displayed until a subsequent pinch-out gesture is detected. When the pinch-out gesture is detected in portable terminal 300, the file temporarily stored is stored in a folder identified by that gesture, and the icon presenting that file is displayed. Further, at this time, CPU 30 outputs a signal indicating that a file request has been sent to MFP 100. CPU 10 of MFP 100 having received this signal deletes the file to be transferred from its own memory 16 or the inserted external storage device.

This “temporary” period is preset at, for example, 24 hours or the like, and when there is no pinch-out gesture detected in portable terminal 300 after the lapse of that period, CPU 30 of portable terminal 300 deletes the file to be transferred having been temporarily stored, and makes a report to that effect to MFP 100. Further, in response to this report, CPU 10 may cause operation panel 15 to display a warning indicating that file transfer has not been completed, or may transmit a message to that effect to portable terminal 300.

### Variation 2

In the above example, the file to be transferred shall be output directly from MFP 100 to portable terminal 300. However, as another example, a file may be output through server 500 shown in FIG. 1.

In this case, at least part of the functional configuration of MFP 100 shown in FIG. 9 may be included in server 500. As an example, file control unit 105 and request input unit 107 may be included in server 500.

At this time, MFP 100 outputs a file identified as a file to be transferred to server 500 together with information that identifies a user (login user) having performed that gesture. File control unit 105 included in server 500 temporarily stores the file to be transferred received from MFP 100 together with the information that identifies the user.

Upon detection of the pinch-in gesture, portable terminal 300 accesses server 500 using an address on the network previously stored, and sends a file request together with the above-described information that identifies the user. File control unit 105 included in server 500 authenticates whether or not the user identified by the information included in the file request matches the user associated with the file to be transferred, and when a match occurs, transmits the file to be transferred to portable terminal 300.

It is to be noted that the foregoing describes the process in which a file is transferred from MFP 100 to portable terminal 300, as an example. By exchanging MFP 100 and portable terminal 300 in the above description, a file will be transferred from portable terminal 300 to MFP 100 in a similar manner. Specifically, a file to be transferred is identified by the pinch-in gesture on the file list displayed on operation panel 34 of portable terminal 300, and the file to be transferred is requested by the pinch-out gesture on the operation screen displayed on operation panel 15 of MFP 100, and that file is stored in an identified folder. That is, in this case, a file can also be transferred from portable terminal 300 to MFP 100 by intuitive and easy manipulations.

Further, a program for causing the operations in MFP 100 and the operations in portable terminal 300 described above to be performed can also be offered. Such a program can be recorded on a computer-readable recording medium, such as a flexible disk attached to a computer, a CD-ROM (Compact Disk-Read Only Memory), a ROM, a RAM, a memory card, or the like, and can be offered as a program product. Alternatively, a program can be offered as recorded on a recording medium such as a hard disk built in a computer. Still alternatively, the program can also be offered by downloading through a network.

It is noted that the program according to the present invention may cause the process to be executed by invoking a necessary module among program modules offered as part of an operating system (OS) of a computer with a predetermined timing in a predetermined sequence. In that case, the program itself does not include the above-described module, but the process is executed in cooperation with the OS. Such a program not including a module may also be covered by the program according to the present invention.

Moreover, the program according to the present invention may be offered as incorporated into part of another program. Also in such a case, the program itself does not include the module included in the above-described other program, and the process is executed in cooperation with the other program. Such a program incorporated into another program may also be covered by the program according to the present invention.

An offered program product is installed in a program storage unit, such as a hard disk, and is executed. It is noted that the program product includes a program itself and a recording medium on which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming apparatus comprising:
a touch panel;
a controller connected to said touch panel;
a memory for storing a data file; and
a communication device for communicating with an other device, wherein
continuously after two contacts are made on said touch panel, when a first gesture of moving said two contacts in a direction that a spacing therebetween is decreased and then releasing said two contacts after being moved is detected, said controller identifies a file presented by an icon displayed in an area defined by said two contacts at least either of before and after being moved, as a file to be transferred, and transfers said file to be transferred to said other device in response to a request to transfer a file from said other device received by said communication device.

2. The image forming apparatus according to claim 1, wherein said controller performs user authentication using user information to associate said file to be transferred with a user having performed said first gesture, and when a user identified by information included in said request matches the user associated with said file to be transferred, transfers said file to be transferred to said other device.

3. The image forming apparatus according to claim 1, wherein said controller outputs said file to be transferred to said other device in response to said request sent after said first gesture, thereby transferring said file to be transferred to said other device.

4. The image forming apparatus according to claim 1, wherein said controller previously stores said other device as a destination of said file to be transferred, and outputs said file to be transferred to said other device after said first gesture and before said request, thereby transferring said file to be transferred to said other device.

5. The image forming apparatus according to claim 4, wherein said controller copies said file to be transferred, outputs the copied file to said other device, and deletes said file to be transferred from said memory in response to said request from said other device.

6. The image forming apparatus according to claim 1, wherein when said request is not sent within a predetermined period after identification of said file to be transferred, said controller cancels identification of said file to be transferred.

7. The image forming apparatus according to claim 1, wherein continuously after two contacts are made, when a second gesture of moving said two contacts in a direction that the spacing therebetween is increased and then releasing said two contacts after being moved is detected on display of said touch panel showing a folder presenting a storage location where said file to be transferred is stored, said controller cancels identification of said file to be transferred.

8. The image forming apparatus according to claim 1, wherein when said request is not sent within a predetermined period after identification of said file to be transferred, said controller causes a warning to that effect to be output.

9. The image forming apparatus according to claim 1, wherein said controller identifies a plurality of files presented by a plurality of icons displayed in the area defined by said two contacts at least either of before and after being moved, as files to be transferred.

10. The image forming apparatus according to claim 1, wherein when an icon presenting a folder is displayed in the area defined by said two contacts at least either of before and after being moved, said controller identifies a plurality of files stored in said folder as files to be transferred.

11. The image forming apparatus according to claim 1, wherein when said first gesture is detected, said controller changes the shape of the icon displayed between said two contacts along with moving said two contacts.

12. The image forming apparatus according to claim 1, wherein continuously after two contacts are made on said touch panel, when a second gesture of moving said two contacts in a direction that the spacing therebetween is increased and then releasing said two contacts after being moved is detected, said controller further executes the processes of:
identifying a storage location displayed in an area defined by said two contacts at least either of before and after being moved, as the storage location of said file to be transferred;
sending a request to said other device to transfer a file; and
storing the file transmitted from said other device in said storage location.

13. A terminal device comprising:
a touch panel;
a controller connected to said touch panel; and
a communication device for communicating with an image forming apparatus, wherein continuously after two contacts are made on said touch panel, when a first gesture of moving said two contacts in a direction that a spacing therebetween is increased and then releasing said two contacts after being moved is detected,
said controller executes the processes of:
identifying a storage location displayed in an area defined by said two contacts at least either of before and after being moved, as the storage location of a file to be transferred;
sending a request to said image forming apparatus to transfer a file; and
storing said file to be transferred transmitted from said image forming apparatus in said storage location.

14. The terminal device according to claim 13, wherein said controller transmits information that identifies a user previously stored together with said request, to said image forming apparatus.

15. The terminal device according to claim 13, wherein said request includes information indicating that said first gesture has been detected.

16. The terminal device according to claim 13, wherein when said first gesture is detected, said controller causes an icon presenting said file to be transferred transmitted from said image forming apparatus to be displayed between said two contacts, and changes the shape of the icon displayed along with moving said two contacts.

17. The terminal device according to claim 16, wherein
said file to be transferred transmitted from said image forming apparatus has associated therewith information at the time of identification of said file to be transferred in said image forming apparatus, and
said controller causes the information at the time of identification of said file to be transferred in said image forming apparatus to be displayed together with said icon.

18. The terminal device according to claim 13, wherein continuously after two contacts are made on said touch panel, when a second gesture of moving said two contacts in a direction that the spacing therebetween is decreased and then releasing said two contacts after being moved is detected,
said controller identifies a file presented by an icon displayed in an area defined by said two contacts at least either of before and after being moved, as a file to be transferred, and transfers said file to be transferred to said image forming apparatus in response to a request from said image forming apparatus received by said communication device.

19. An image forming system comprising:
an image forming apparatus; and
a terminal device,
said image forming apparatus and said terminal device each including a touch panel and a controller connected to said touch panel, wherein
continuously after two contacts are made on said touch panel, when a first gesture of moving said two contacts in a direction that a spacing therebetween is decreased and then releasing said two contacts after being moved is detected, said controller of a first device out of said image forming apparatus and said terminal device identifies a file presented by an icon displayed in an area defined by said two contacts at least either of before and after being moved, as a file to be transferred, and transfers said file to be transferred to a second device out of said image forming apparatus and said terminal device in response to a request from said second device, and
continuously after two contacts are made on said touch panel, when a second gesture of moving said two contacts in a direction that the spacing therebetween is increased and then releasing said two contacts after being moved is detected, said controller of said second device executes the processes of:
identifying a storage location displayed in the area defined by said two contacts at least either of before and after being moved, as the storage location of said file to be transferred;
sending a request to transfer a file; and
storing said file to be transferred transmitted from said second device in said storage location.

20. The image forming system according to claim 19, further comprising a server, wherein
said controller of said first device transmits said file to be transferred to said server for storage,
said controller of said second device requests said server to transfer a file, and
said controller of said first device outputs said file to be transferred as stored to said second device in response to said request.

21. A non-transitory computer-readable storage medium having recorded thereon a program for causing an image processing apparatus having a touch panel and a controller connected to said touch panel to execute a process of transferring a stored file to an other device, wherein said program instructs said controller to perform the following steps of:
continuously after two contacts are made on said touch panel, detecting a gesture of moving said two contacts in a direction that a spacing therebetween is decreased and then releasing said two contacts after being moved;
when said gesture is detected, identifying a file presented by an icon displayed in an area defined by said two contacts at least either of before and after being moved, as a file to be transferred; and
transferring said file to be transferred to said other device in response to a request to transfer a file from said other device.

22. A non-transitory computer-readable storage medium having recorded thereon a program for causing a terminal device having a touch panel and a controller connected to said touch panel to execute a process of transferring a file stored in an image processing apparatus to said terminal device, wherein said program instructs said controller to perform the following steps of:
continuously after two contacts are made on said touch panel, detecting a gesture of moving said two contacts in a direction that a spacing therebetween is increased and then releasing said two contacts after being moved;
when said gesture is detected, identifying a storage location displayed in an area defined by said two contacts at least either of before and after being moved, as the storage location of a file to be transferred;
when said gesture is detected in said detecting step, sending a request to said image processing apparatus to transfer a file;
receiving said file to be transferred transmitted from said image processing apparatus; and
storing said file to be transferred in said storage location.
